(19) United States
(12) Patent Application Publication
(10) Pub. No.: US 2026/0018158 A1
(43) Pub. Date: Jan. 15, 2026

(54) SYSTEMS AND METHODS FOR ENGINE SOUND ENHANCEMENT

(71) Applicant: Bose Corporation, Framingham, MA (US)

(72) Inventors: Mark Vandergeest, Milford, MI (US); Joseph Landry, West Bloomfield, MI (US)

(73) Assignee: Bose Corporation, Framingham, MA (US)

(21) Appl. No.: 18/771,449

(22) Filed: Jul. 12, 2024

(51) Int. Cl. G10K 15/02

(52) U.S. Cl. CPC G10K 15/02

(57) ABSTRACT

An ESE system is provided. The ESE system includes a controller. The controller is configured to receive an RPM signal from an engine control unit ECU. The controller is further configured to calculate a reference frequency of engine vibrations based on the RPM signal. The controller is further configured to generate one or more waveforms. Each of the one or more waveforms has a playback rate based on the reference frequency. A first waveform of the one or more waveforms includes a first pulse modified by a first pulse variation. The controller is further configured to generate an ESE output signal based on the one or more waveforms. The controller is further configured to provide the ESE output signal to an audio output system.

### FIELD OF THE DISCLOSURE

The present disclosure is generally directed to engine sound enhancement, and more specifically, to systems and methods for enhancing engine sounds of a vehicle by processing one or more waveforms corresponding to engine revolutions.

### BACKGROUND

Engine sound enhancement systems provide enhanced sound to modify the sonic and/or vibratory experience of a vehicle driver, a vehicle occupant, and/or a person nearby the vehicle. For example, an engine sound enhancement system may allow the occupants to experience the engine sound at a loud and stimulating level, without being disruptively loud to persons outside the vehicle. Further, the engine sound enhancement could adjust the various characteristics of the sound other than volume (such as frequency response) to create a more desirable engine sound.

Some engine sound enhancement systems use engine harmonic enhancement to create the desired engine sound to be played by an audio system of the vehicle. Typical engine harmonic enhancement systems synthesize a number of harmonic orders of a fundamental sine wave to generate the desired engine sound. In some cases, up to 65 harmonic orders are required, which requires a significant amount of processing resources.

### SUMMARY

The present disclosure is generally directed to systems and methods for engine sound enhancement (ESE) for use in a vehicle. In particular, the present disclosure describes generating and synthesizing a small number of waveforms (such as four or less) to be combined and provided to an audio output signal. Each of the waveforms is defined by a playback rate and one or more pulses (such as two, four, or eight pulses) within the duration of a playback period corresponding to the playback rate. The playback rate for each waveform is derived from a reference frequency. The reference frequency is calculated from a revolutions per minute (RPM) signal provided by an engine control unit (ECU). The quantity of the generated waveforms and the additional parameters (amplitude, number of pulses, etc.) of each of the waveforms are determined according to one or more vehicle properties (such as vehicle manufacturer, vehicle model, model year, manufacture year, etc.). These additional parameters may vary among the waveforms. For example, vehicle A may use waveforms A, B, C, and D for ESE, while vehicle B may use waveforms E, F, and G. These waveforms may be generated via a tuning process and stored in a memory for retrieval during operation.

The pulses of the waveforms may be substantially sinusoidal. Further, each pulse is modified by a pulse variation, and the pulse variation may also be substantially sinusoidal. The period and amplitude of the pulse variation are typically significantly less than the period and amplitude of the modified pulse. Further, the pulse variation is applied at a delay time within the period of the pulse. For waveforms having multiple pulses, the pulse variations may vary from pulse to pulse. For instance, the first pulse variation of the first pulse may differ from a second pulse variation of the second pulse in terms of delay time, amplitude, and/or period. Applying the pulse variations to the waveforms enables a small number of waveforms to generate an ESE output signal previously attainable only by synthesizing a large number (such as 65) of harmonic orders of a sine wave of the reference frequency, thereby significantly reducing processing requirements while improving the generated engine output sound.

Generally, in one aspect, an ESE system is provided. The ESE system includes a controller. The controller is configured to calculate a reference frequency of engine vibrations based on an RPM signal.

The controller is further configured to generate one or more waveforms. Each of the one or more waveforms has a playback rate based on the reference frequency. A first waveform of the one or more waveforms includes a first pulse modified by a first pulse variation.

The controller is further configured to generate an ESE output signal based on the one or more waveforms.

The controller is further configured to provide the ESE output signal to an audio output system.

According to an example, the one or more waveforms are generated based on one or more vehicle properties. The one or more vehicle properties may include vehicle manufacturer, vehicle model, model year, and/or manufacture year.

According to an example, the first pulse variation is applied to the first pulse at a delay time.

According to an example, a period of the first pulse variation is less than a period of the first pulse. The period of the first pulse variation is less than or equal to one-seventh of the period of the first pulse.

According to an example, an amplitude of the first pulse variation is less than an amplitude of the first pulse.

According to an example, the RPM signal corresponds to an equivalent RPM of an ICE vehicle.

According to an example, the first pulse is substantially sinusoidal.

According to an example, the first pulse variation is substantially sinusoidal.

According to an example, the first waveform includes a second pulse modified by a second pulse variation.

According to an example, an amplitude of the first pulse equals an amplitude of the second pulse, and a period of the first pulse equals a period of the second pulse.

According to an example, an amplitude, a delay time, or a period of the second pulse variation differs from an amplitude, a delay time, or a period of the first pulse variation.

According to an example, (a) a delay time of the first pulse variation differs from a delay time of the second pulse variation, or (b) an amplitude of the first pulse variation differs from an amplitude of the second pulse variation, or (c) a period of the first pulse variation differs from a period of the second pulse variation.

Generally, in another aspect, a method for controlling an (ESE) system is provided. The method includes (1) calculating, via a controller of the ESE system, a reference frequency of engine vibrations based on an RPM signal; (2) generating one or more waveforms, wherein each of the one or more waveforms has a playback rate based on the reference frequency, and wherein a first waveform of the one or more waveforms includes a first pulse modified by a first pulse variation; (3) generating, via the controller, an ESE output signal based on at least the waveform; and (4) providing, via the controller, the ESE output signal to an audio output system.

According to an example, the one or more waveforms are generated based on one or more vehicle properties.

According to an example, the first waveform includes a second pulse modified by a second pulse variation.

According to an example, an amplitude of the first pulse equals an amplitude of the second pulse, and wherein a period of the first pulse equals a period of the second pulse.

According to an example, the first pulse is substantially sinusoidal.

According to an example, the first pulse variation is substantially sinusoidal.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also can appear in any disclosure incorporated by reference should be accorded a meaning most consistent with the particular concepts disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a functional block diagram of aspects of an engine sound enhancement system (ESE), in accordance with an example.

FIG. 2 illustrates a waveform generated by an ESE, in accordance with an example.

FIG. 3 illustrates a frequency spectrum associated with a second order harmonic of the waveform of FIG. 2, in accordance with an example.

FIG. 4A illustrates a waveform generated by an ESE with a first pulse variation, in accordance with an example.

FIG. 4B illustrates the waveform of FIG. 4B, in accordance with an example.

FIG. 5 illustrates a frequency spectrum associated with the waveform of FIGS. 4A and 4B, in accordance with an example.

FIG. 6A illustrates a waveform generated by an ESE with two pulses, in accordance with an example.

FIG. 6B illustrates the waveform of FIG. 4B, in accordance with an example.

FIG. 7 illustrates example waveforms having two, four, and eight pulses, in accordance with an example.

FIG. 8 illustrates an example tuning interface, in accordance with an example.

FIG. 9 illustrates four waveforms associated with the tuning interface of FIG. 8, in accordance with an example.

FIG. 10 illustrates a frequency spectrum associated with the waveforms of FIG. 9, in accordance with an example.

FIG. 11 is a flow chart of a method for controlling an ESE system, in accordance with an example.

### DETAILED DESCRIPTION

The present disclosure is generally directed to systems and methods for engine sound enhancement (ESE) for use in a vehicle. In particular, the present disclosure describes generating and synthesizing a small number of waveforms to be combined and provided to an audio output signal. Each of the waveforms is defined by a playback rate and one or more pulses within the duration of a playback period corresponding to the playback rate. The playback rate for each waveform is derived from a reference frequency. The reference frequency is calculated from a revolutions per minute (RPM signal) provided by an engine control unit (ECU). The quantity of the generated waveforms and the additional parameters of each of the waveforms are determined according to one or more vehicle properties. These additional parameters may vary among the waveforms. These waveforms may be generated via a tuning process and stored in a memory for retrieval during operation. The pulses of the waveforms may be substantially sinusoidal. Further, each pulse is modified by a pulse variation, and the pulse variation may also be substantially sinusoidal. The period and amplitude of the pulse variation are typically significantly less than the period and amplitude of the modified pulse. Further, the pulse variation is applied at a delay time within the period of the pulse. For waveforms having multiple pulses, the pulse variations may vary from pulse to pulse. For instance, the first pulse variation of the first pulse may differ from second pulse variation of the second pulse in terms of delay time, amplitude, and/or period.

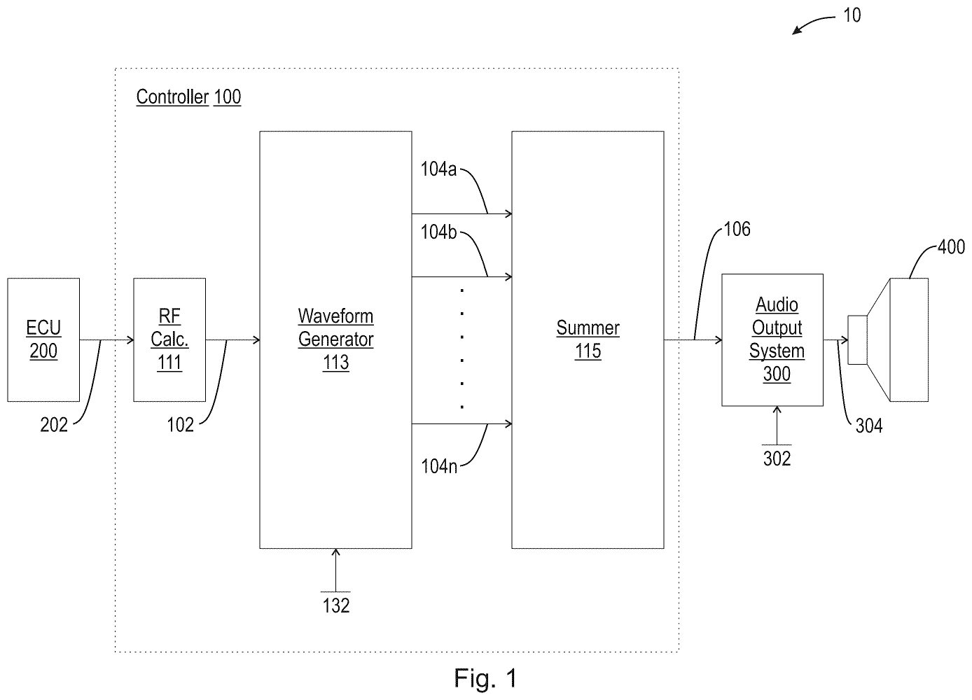

The following description should be read in view of FIGS. 1-11.

FIG. 1 is a functional block diagram of a non-limiting example of an ESE system 10. The ESE system 10 may be implemented in any type of vehicle, such as an automobile or passenger car, including, but not limited to sedans, vans, sport utility vehicles, station wagons, pickup trucks, etc. Broadly, the ESE system 10 includes a controller 100, an ECU 200, an audio output system 300, and one or more audio speakers 400. The speakers 400 are typically arranged within the cabin of the vehicle, though the speakers 400 may also be placed in different positions around the vehicle as needed.

The ECU 200 may be coupled to various electrical and/or mechanical aspects of the vehicle to determine an RPM measurement for the engine of the vehicle. For example, the ECU 200 may be coupled to a tachometer configured to capture the RPM of the vehicle. The ECU 200 then provides an RPM signal 202 representing the RPM of the engine to the controller 100. In other examples, the RPM signal 202 could be provided to the controller 100 by other components or aspects of the vehicle. In some examples, the engine is an internal combustion engine (ICE). In these examples, the RPM signal 202 would correspond to the RPM of the ICE. In other examples, the engine may be an electric motor of an electric vehicle (EV). In these examples, the RPM signal 202 would correspond to the RPM of the electric motor. In further examples, the RPM signal 202 may correspond to an equivalent RPM of a traditional drivetrain, e.g., an ICE vehicle with a suitable gear ratio corresponding to the EV's speed, torque, etc. By corresponding to the equivalent RPM of a traditional drivetrain, the RPM signal 202 of the EV can be used to generate audio to make the EV sound more like a traditional, ICE vehicle. The RPM signal 202 may be determined by translating the RPM of the EV to an equivalent RPM of an ICE vehicle. This translation may be performed by the ECU 200 or by other aspects of the ESE system 10, such as the controller 100. In some examples, one of more of speed, acceleration, and/or torque of an EV engine may be used to determine a corresponding gear and the equivalent RPM of an ICE engine. Thus, in some examples, the RPM signal 202 may directly represent the rotational rate of a motor, while in other examples, the RPM signal 202 may instead be generated based on one or more characteristics of the motor and/or the vehicle, rather than simply representing the rotational rate of the motor.

The RPM signal 202 is provided to a reference frequency calculator 111. The reference frequency calculator 111 is configured to generate a reference frequency signal 102. The reference frequency signal 102 represents the frequency of the engine vibrations. In some examples, a frequency value conveyed by the reference frequency signal 102 may be determined by dividing the RPM of the engine by 60. Thus, for example, if the engine is producing 1,500 RPM, the reference frequency 102 of the engine vibrations is considered to be 25 Hz.

The reference frequency signal 102 is then provided to a waveform generator 113. The waveform generator 113 then generates a group of one or more waveforms 104. In some examples, the waveform generator 113 may also receive one or more vehicle properties 132, such as vehicle manufacturer, vehicle model, model year, and/or manufacture year. The waveform generator 113 then retrieves one or more stored waveforms 104 based on the vehicle properties 132. Accordingly, the group of waveforms 104 may be created and tuned for optimal performance in advance of user operation, such as during manufacturing. The retrieved waveforms 104 are described in more detail below. Each of the retrieved waveforms 104 is also assigned an order value defining how many times the waveform 104 cycles for each engine revolution and a playback rate based on the order value and the reference frequency 102.

For example, a first waveform 104a with an order value of 1 cycles one time for every engine revolution. If the reference frequency 102 is 25 Hz, the playback rate of the first waveform 104a is also 25 Hz. In another example, a second waveform 104b with an order value of 2 cycles two times for every engine revolution. If the reference frequency 102 is 25 Hz, the playback rate of the second waveform 104b is 50 Hz, or twice as fast as the first waveform 104a. In a further example, a third waveform 104c with an order value of 0.5 cycles one time for every two engine revolutions. If the reference frequency 102 is 25 Hz, the playback rate of the third waveform 104c is 12.5 Hz, or half as fast as the first waveform 104a. The waveform generator 113 may be configured to retrieve all three of the example waveforms 104a, 104b, 104c for a specific vehicle corresponding to the provided vehicle properties 132.

The retrieved waveforms 104 are then combined by the summer 115 to generate an ESE output signal 106. The ESE output signal 106 represents the engine sounds to be played by the audio system of the vehicle to enhance or augment the sounds of the vehicle. Generally, the more waveforms 104 combined by the summer 115, the more natural or authentic the enhanced engine audio will sound. However, greater numbers of waveforms 104 combined by the summer 115 will require greater computing resources and/or processing capabilities.

The ESE output signal 106 is then provided to the audio output system 300. The audio output system 300 controls the audio played back by the various speakers arranged throughout the vehicle. The audio output system 300 also receives one or more additional audio inputs 302 for playback, such as entertainment audio. In some examples, the ESE output signal 106 could be combined and/or mixed with the additional audio inputs 302. In further examples, prior to combining or mixing with the additional audio inputs 302, the audio output system 300 may further process the ESE output signal 106, such as through one or more of up-sampling, expansion, interpolation, filtration, amplification, attenuation, etc. The audio output system 300 provides an audio output signal 304 (generated based on at least the ESE output signal 106 and the additional audio inputs 302) to one or more audio speakers 400 for play back.

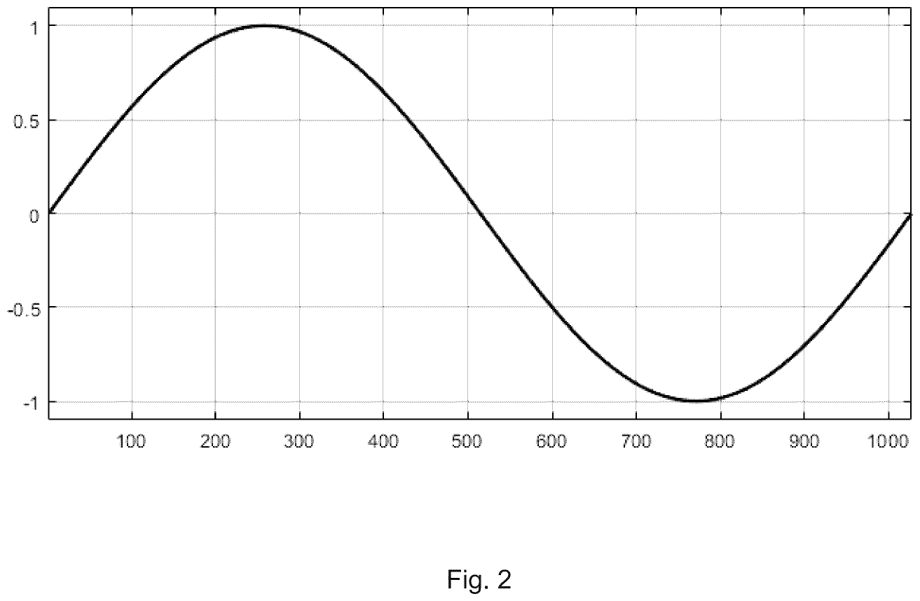

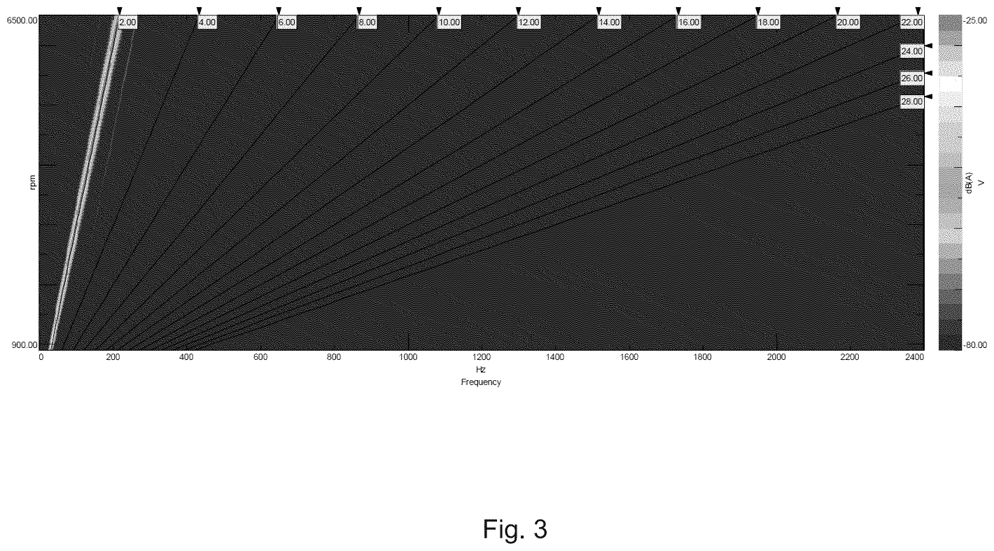

FIG. 2 illustrates an example of a previous sinusoidal waveform used to generate an ESE output signal 106. The y-axis of FIG. 2 represents the amplitude of the waveform. In the example of FIG. 2, the amplitude ranges from −1 to 1. Thus, the units of the y-axis are the percentage of full scale of the sinusoidal waveform, where 1 equals 100% of the amplitude capability of the controller 100 generating the waveform. The x-axis of FIG. 2 represents the number of points used to define the waveform. The number of points in the wave corresponds to the resolution of the waveform; the greater the number of points, the higher the resolution. As the sinusoidal waveform completes one full cycle in the given period, the sinusoidal waveform is considered to be a first order harmonic waveform. FIG. 3 illustrates the frequency spectrum covered by a second order harmonic waveform corresponding to the first order sinusoidal waveform of FIG. 2. As shown, the frequency of the second order harmonic waveform corresponds to the RPM of the engine of the vehicle. For example, if the engine rotates at 3,000 rpm, the second order sinusoidal waveform oscillates at approximately 100 Hz. Accordingly, a single second order harmonic waveform only provides noise enhancement in a limited frequency range, thereby requiring a high number (such as up to 65) of additional harmonic order waveforms to generate a robust ESE output signal 106.

In order to create a more robust ESE output signal 106, a waveform 104 is modified by adding a pulse variation 110. These pulse variations 110 enable the waveform 104 to emulate pressure-torque pulses of an engine more accurately, thereby requiring the summation of fewer waveforms 104 (such as 3 or 4, rather than 65) to generate a robust ESE output signal 106. Further, various parameters (as will be discussed below) of the pulse variations 110 may be tuned to specifically emulate audio characteristics of specific engines.

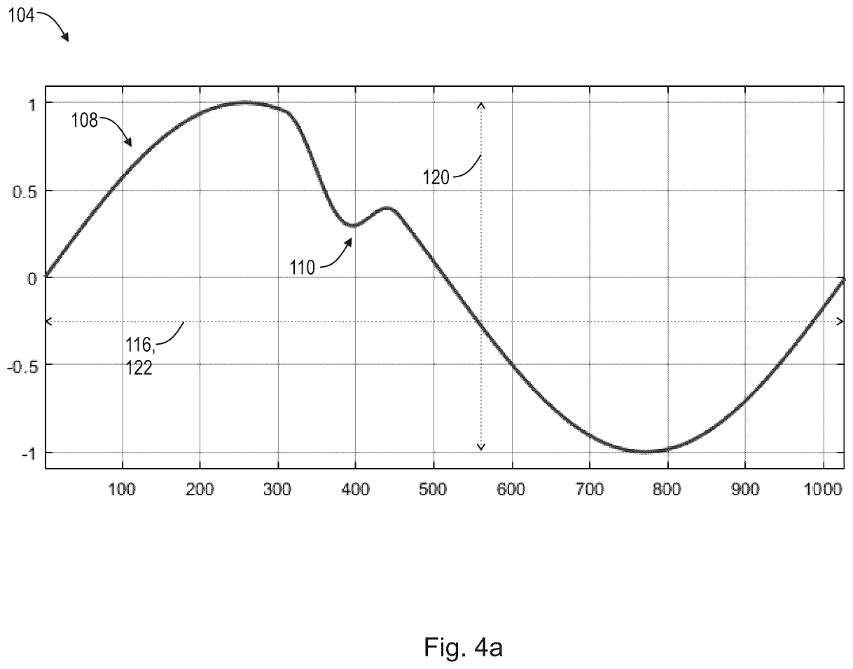

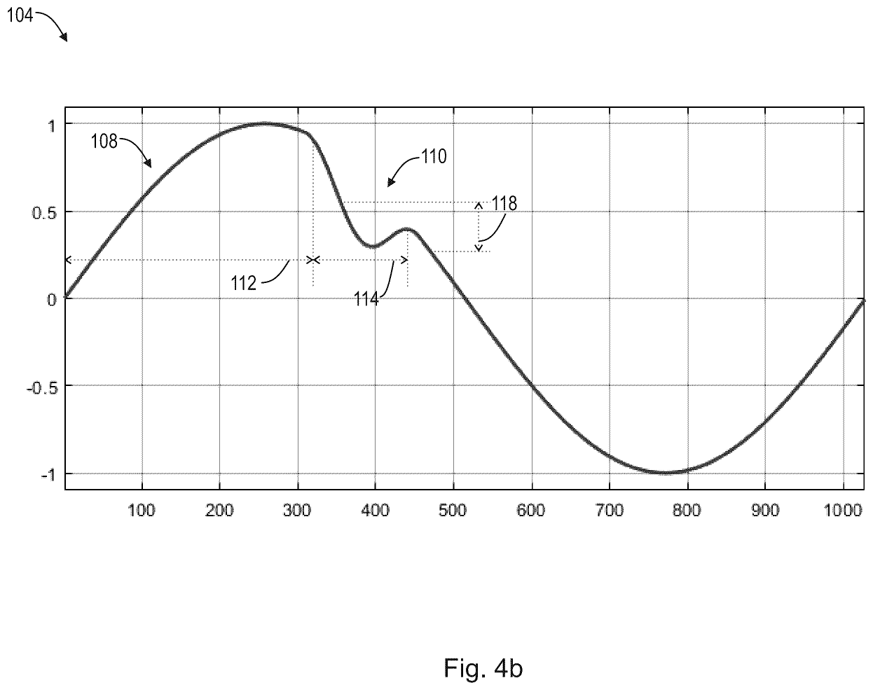

In the non-limiting example of FIG. 4A, the waveform 104 comprises a single pulse 108. The overall waveform 104 is defined by a playback period 122. The waveform 104 is assigned an order value of first order. Accordingly, the playback period 122 may be obtained by simply inverting the reference frequency 102. The pulse 108 is defined by a period 116 and an amplitude 120.

The pulse 108 includes a pulse variation 110. In the non-limiting example of FIG. 4A, the pulse variation 110 is substantially sinusoidal, such as a cosine waveform. However, in other examples, the pulse variation 110 may take other tunable forms. The various tunable parameters of the pulse variation 110 are illustrated in FIG. 4B. As shown in FIG. 4B, the pulse variation 110 is defined by a delay time 112, a period 114, and an amplitude 118.

The delay time 112 represents the amount of time between the start of the period 116 of the pulse 108 to the start of the period 114 of the pulse variation 110 relative to the period 116 of the pulse 108. Accordingly, the delay time 112 of the non-limiting example of FIG. 4B is approximately 0.30. Similarly, the period 114 of the pulse variation 110 is described in relation to the period 116 of the pulse 108. Accordingly, the period 114 of the pulse variation 110 of the non-limiting example of FIG. 4B is approximately 0.14. Further, the amplitude 118 of the pulse variation 110 is described in relation to the amplitude 120 of the pulse 108. Accordingly, the amplitude 118 of the pulse variation 110 of the non-limiting example of FIG. 4B is approximately 0.20.

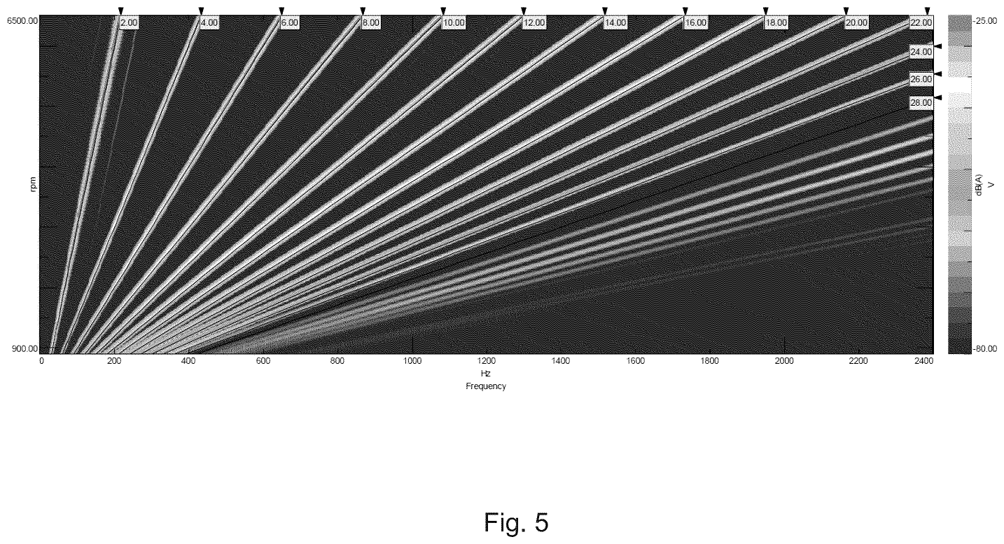

FIG. 5 shows the frequency spectrum of the waveform 104 of FIGS. 4A and 4B. In the example of FIG. 5, the waveform 104 has been assigned an order value of 2, resulting in a playback rate of twice the reference frequency 102. As shown in FIG. 5, implementing the pulse variation 110 in the pulse 108 results in significantly broader and more robust frequency spectrum as compared to FIG. 3. Rather than just covering the frequency and RPM combinations associated with the second order harmonic, frequency and RPM combinations associated with integer multiples of the second order harmonic, such as fourth order, sixth order, eighth order, etc.

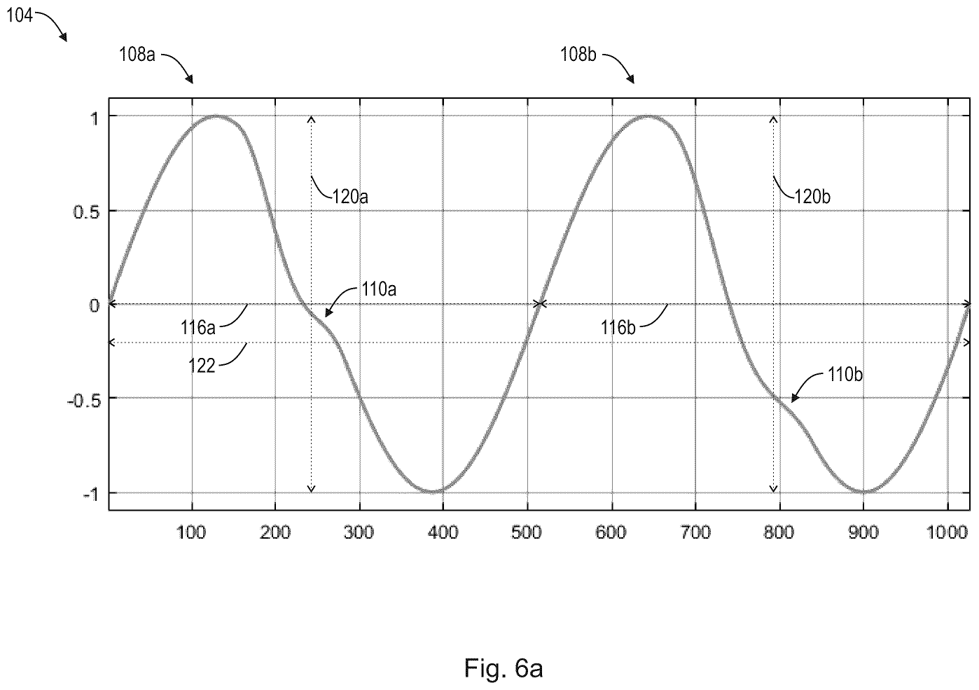

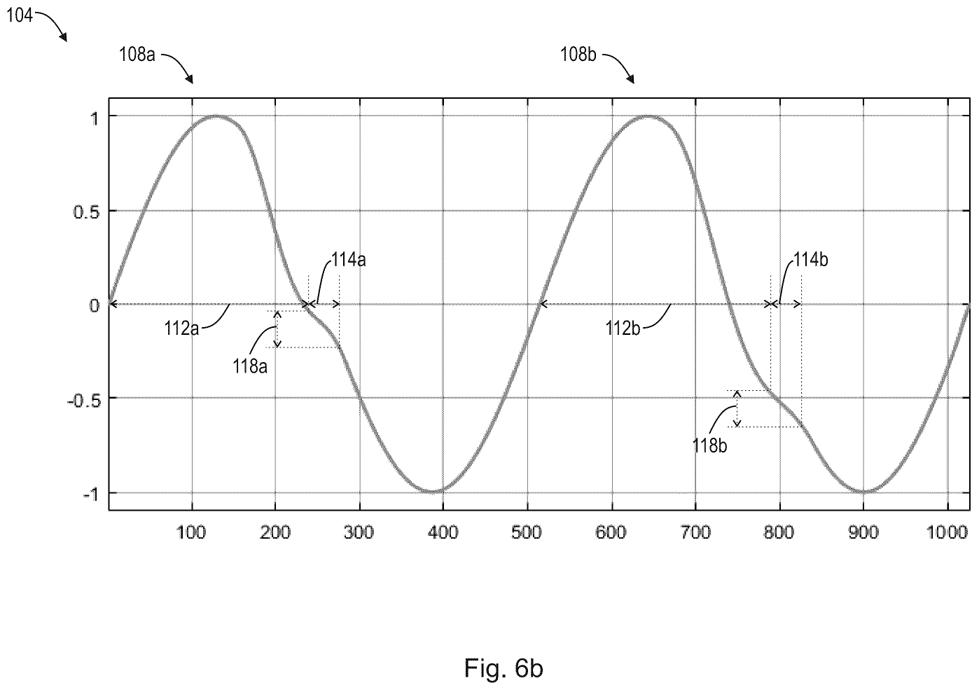

FIG. 6A illustrates a further example of a waveform 104. In the non-limiting example of FIG. 6A, the waveform 104 has been modified by two pulses 108a, 108b. In this example, the waveform 104 completes two full cycles within the waveform period 122. Accordingly, while this waveform 104 may be associated with various order values of the reference frequency 102, the waveform 104 of FIG. 6A may be considered a “second order dominant” waveform.

As shown in FIG. 6B, each pulse 108a, 108b is modified by a pulse variation 110a, 110b. The first pulse variation 110a is defined by a delay time 112a, a period 114a, and an amplitude 118a. The second pulse variation 110b is similarly defined by a delay time 112b, a period 114b, and an amplitude 118b. As shown in FIG. 6B, the delay time 112a of the first pulse variation 110a varies from the delay time 112b of the second pulse variation 110b. Further, in some examples, the periods 114a, 114b and/or the amplitudes 118a, 118b may vary from between pulse variations 110a, 110b. The differences between pulse variations 110a, 110b may impart additional robustness into the frequency spectrum covered by the waveform 104.

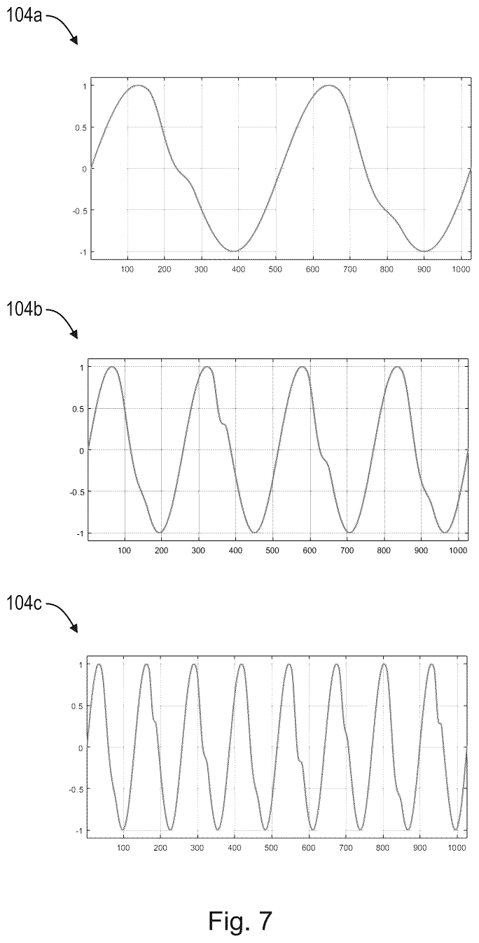

FIG. 7 illustrates three example waveforms 104a, 104b, 104c. The first waveform 104a includes two pulses 108, and is therefore considered a second order dominant waveform. The second waveform 104b includes four pulses 108, and is therefore considered a fourth order dominant waveform. The third waveform 104c includes eight pulses 108, and is therefore considered an eighth-order dominant waveform. As shown in each of the example waveforms 104a, 104b, 104c, the parameters of the pulse variations 110 vary from pulse to pulse. In particular, the pulse variations 110 appear to vary in terms of delay time 112. As previously mentioned, the differences between pulse variations 110 may impart additional robustness into the frequency spectrum covered by the waveforms 104a, 104b, 104c.

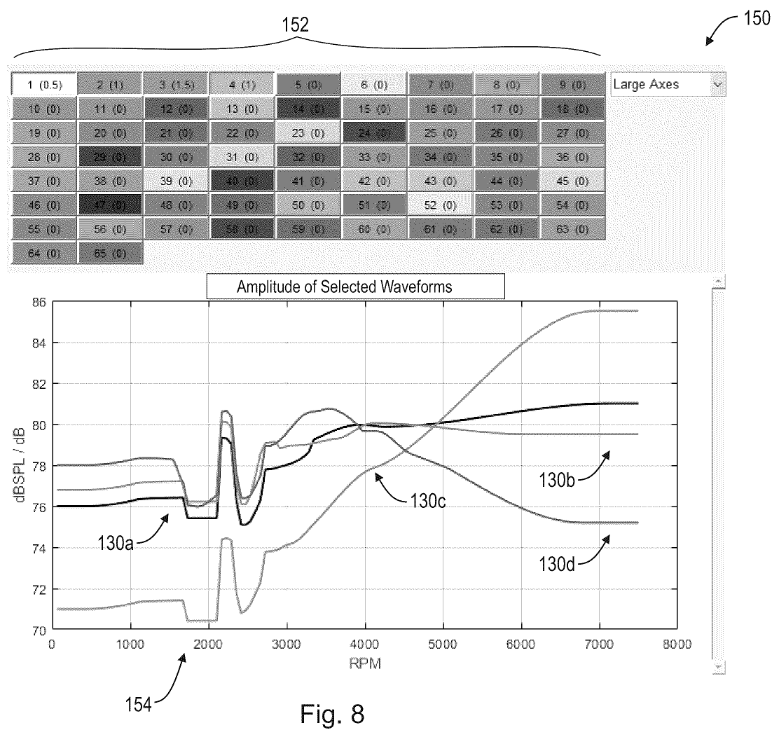

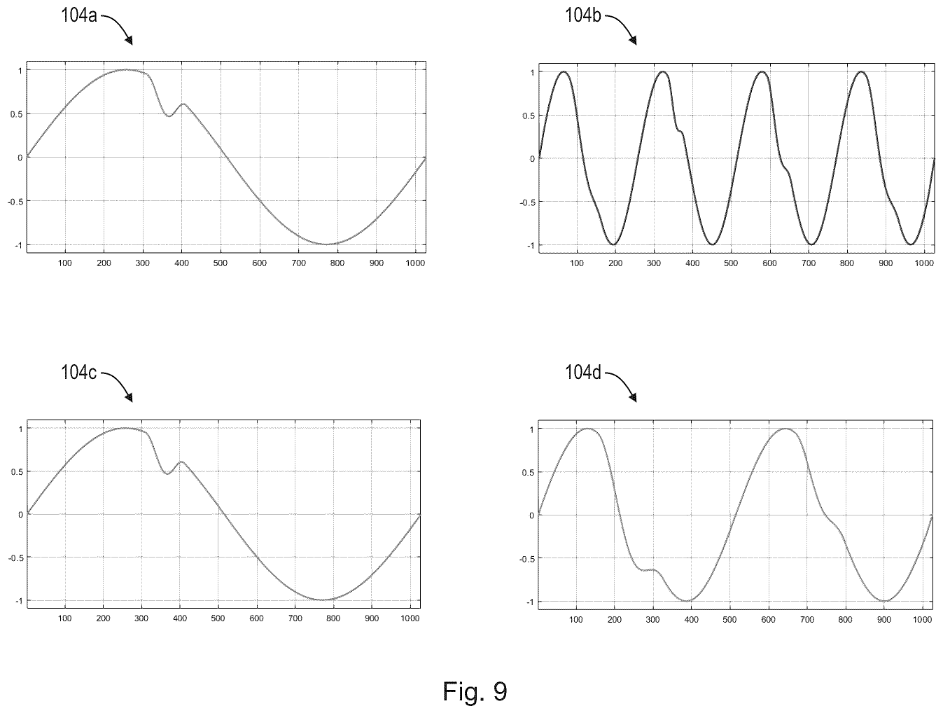

FIG. 8 illustrates an example tuning interface 150, while FIG. 9 illustrates four waveforms 104a-d associated with the selected tuning. As previously described, the selected tuning may be specific to one or more vehicle properties, such as vehicle manufacturer, vehicle model, model year, and/or manufacture year. For example, the selected tuning could correspond to all sedans manufactured by a specific manufacturer in the year 2024. In other examples, the selected tuning could correspond to a specific model made by the manufacturer in the year 2024. The tunings may be programmed during manufacturing of the vehicle or provided as a firmware update during the lifespan of the vehicle.

As can be seen in FIG. 8, the upper portion of the tuning interface 150 includes a plurality of buttons 152 to select various waveforms. The buttons 152 correspond to 65 potential waveforms 104. Each button includes a waveform reference number and, in parentheses, the order value for the waveform 104. As shown in FIG. 8, first, second, third, and fourth waveforms 104a-d have been selected to be implemented with a vehicle having the specified vehicle properties 132. The first waveform 104a has an order value of one-half (0.5) order. The second and fourth waveforms 104b, 104d have an order value of first (1) order. The third waveform 104c has an order value of one-and-one-half (1.5) order. The waveforms 104a-d are shown in FIG. 9.

Below the buttons 152 is a plot of the varying amplitude (expressed as sound pressure) of each of the selected waveforms 104a-d over a range of RPMs. The varying amplitudes of the waveforms 104a-d may also be tuned during the tuning process. A first amplitude plot 130a corresponds to the first waveform 104a, a second amplitude plot 130b corresponds to the second waveform 104b, a third amplitude plot 130c corresponds to the third waveform 104c, and a fourth amplitude plot 130d corresponds to the fourth waveform 104d. As shown in the example of FIG. 8, the amplitude of the third waveform 104c is tuned to be less than the amplitudes of the other waveforms 104a, 104b, 104d below 4,500 RPM and greater than the other waveforms 104a, 104b, 104d above 5,000 RPM. In other examples, the amplitudes of the waveforms 104a-d may be tuned according to other parameters, such as RPM change, vehicle speed, or vehicle acceleration.

FIG. 9 illustrates a series of waveforms 104a-d corresponding to the selected buttons 152 in FIG. 8. As shown in FIG. 1, these waveforms 104a-d will be combined by the summer 115 to generate the ESE output signal 106. The waveforms 104a-d shown in FIG. 9 are not adjusted according to their amplitude plots 130a-d shown in FIG. 8.

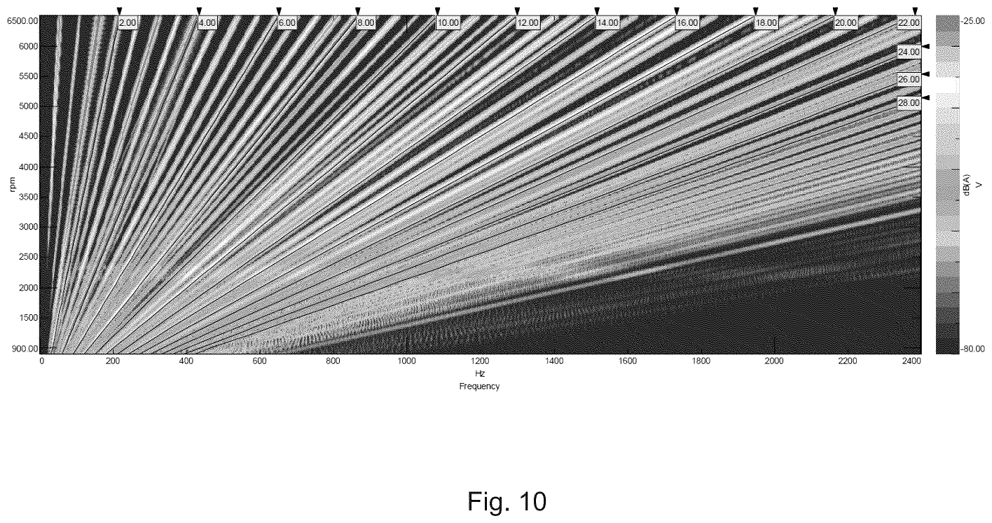

The first waveform 104a has a single pulse and is assigned an order value of 0.5. The second waveform 104b has four pulses and is assigned an order value of 1. Thus, the second waveform 104b may be considered to be fourth order dominant. The third waveform 104c has one pulse and is assigned an order value of 1.5. The fourth waveform 104d has two pulses and is assigned an order value of 1. Thus, the fourth waveform 104d may be considered to be second order dominant. Accordingly, for every two engine revolutions, one cycle of the first waveform 104a is generated, two cycles of the second waveform 104b are generated (resulting in eight total pulses), three cycles of the third waveform 104c are generated, and two cycles of the fourth waveform 104d are generated (resulting in four total pulses). Further, as can be seen in FIG. 9, the pulse variations of the pulses in the second and fourth waveforms 104b, 104d vary from pulse to pulse. FIG. 10 illustrates the robustness of the frequency spectrum generated by combining the four waveforms 104a-d of FIG. 9.

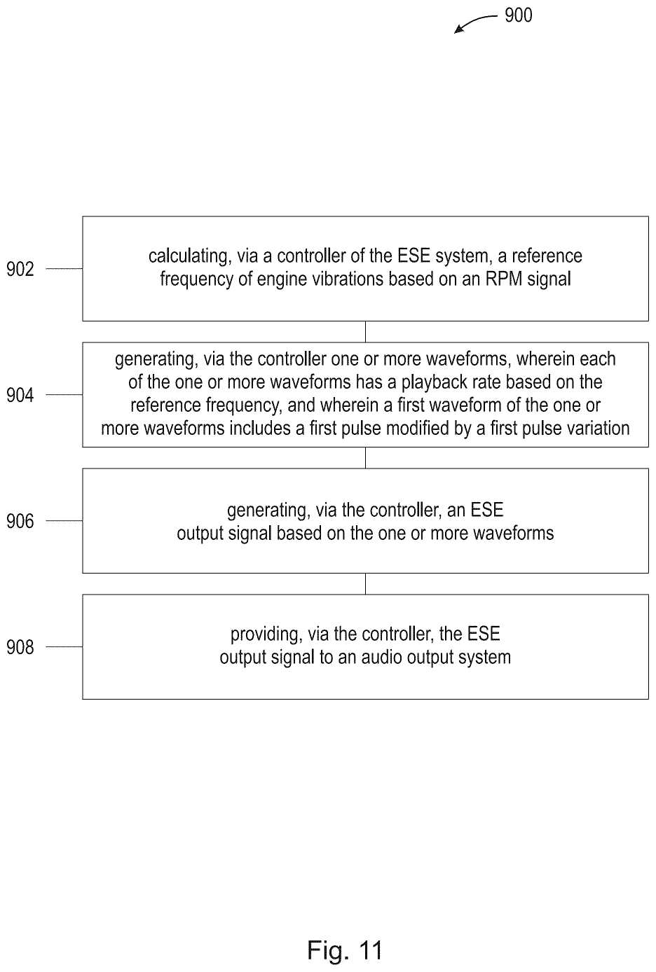

FIG. 11 is a flowchart of a method 900 for controlling an ESE system 10. Referring to FIGS. 1-11, the method 900 includes, in step 902, calculating, via a controller 100 of the ESE system 10, a reference frequency 102 of engine vibrations based on an RPM signal 202.

The method 900 further includes, in step 904, generating, via the controller 100, one or more waveforms 104, wherein each of the one or more waveforms 104 has a playback rate based on the reference frequency 102, and wherein a first waveform 104a of the one or more waveforms 104 includes a first pulse 108 modified by a first pulse variation 110.

The method 900 further includes, in step 906, generating, via the controller 100, an ESE output signal 106 based on the one or more waveforms 104.

The method 900 further includes, in step 908, providing, via the controller 100, the ESE output signal 106 to an audio output system 300.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

What is claimed is:

1. An engine sound enhancement (ESE) system comprising a controller configured to:
calculate a reference frequency of engine vibrations based on a revolutions per minute (RPM) signal;
generate one or more waveforms, wherein each of the one or more waveforms has a playback rate based on the reference frequency, and wherein a first waveform of the one or more waveforms includes a first pulse modified by a first pulse variation;
generate an ESE output signal based on the one or more waveforms; and
provide the ESE output signal to an audio output system.

2. The ESE system of claim 1, wherein the one or more waveforms are generated based on one or more vehicle properties.

3. The ESE system of claim 2, wherein the one or more vehicle properties include vehicle manufacturer, vehicle model, model year, and/or manufacture year.

4. The ESE system of claim 1, wherein the first pulse variation is applied to the first pulse at a delay time.

5. The ESE system of claim 1, wherein a period of the first pulse variation is less than a period of the first pulse.

6. The ESE system of claim 5, wherein the period of the first pulse variation is less than or equal to one-seventh of the period of the first pulse.

7. The ESE system of claim 1, wherein an amplitude of the first pulse variation is less than an amplitude of the first pulse.

8. The ESE system of claim 1, wherein the RPM signal corresponds to an equivalent RPM of an internal combustion engine (ICE) vehicle.

9. The ESE system of claim 1, wherein the first pulse is substantially sinusoidal.

10. The ESE system of claim 1, wherein the first pulse variation is substantially sinusoidal.

11. The ESE system of claim 1, wherein the first waveform includes a second pulse modified by a second pulse variation.

12. The ESE system of claim 11, wherein an amplitude of the first pulse equals an amplitude of the second pulse, and wherein a period of the first pulse equals a period of the second pulse.

13. The ESE system of claim 12, wherein an amplitude, a delay time, or a period of the second pulse variation differs from an amplitude, a delay time, or a period of the first pulse variation.

14. The ESE system of claim 13, wherein (a) a delay time of the first pulse variation differs from a delay time of the second pulse variation, or (b) an amplitude of the first pulse variation differs from an amplitude of the second pulse variation, or (c) a period of the first pulse variation differs from a period of the second pulse variation.

15. A method for controlling an engine sound enhancement (ESE) system, comprising:
calculating, via a controller of the ESE system, a reference frequency of engine vibrations based on a revolutions per minute (RPM) signal;
generating, via the controller, one or more waveforms, wherein each of the one or more waveforms has a playback rate based on the reference frequency, and wherein a first waveform of the one or more waveforms includes a first pulse modified by a first pulse variation;
generating, via the controller, an ESE output signal based on the one or more waveforms; and
providing, via the controller, the ESE output signal to an audio output system.

16. The method of claim 15, wherein the one or more waveforms are generated based on one or more vehicle properties.

17. The method of claim 15, wherein the first waveform includes a second pulse modified by a second pulse variation.

18. The method of claim 17, wherein an amplitude of the first pulse equals an amplitude of the second pulse, and wherein a period of the first pulse equals a period of the second pulse.

19. The method of claim 15, wherein the first pulse is substantially sinusoidal.

20. The method of claim 15, wherein the first pulse variation is substantially sinusoidal.
